(19) United States
(12) Patent Application Publication
(10) Pub. No.: US 2006/0209656 A1
(43) Pub. Date: Sep. 21, 2006

(54) Method For Determining A Write Type Of A Disc

(76) Inventors: Shu-Chin Lin, Chung-Li City (TW); Chih-Tai Cheng, Taipei Hsien (TW); Hung-Ping Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/308,233

(22) Filed: Mar. 14, 2006

(30) Foreign Application Priority Data
Mar. 15, 2005 (TW) 094107835

(51) Int. Cl. G11B 7/00

(52) U.S. Cl. 369/53.37; 369/47.47

(57) ABSTRACT

A method for determining a write type of a disc includes determining whether the disc is a recordable disc or a re-writeable disc, determining whether a lead-in area of the disc comprises a program memory area or not when the disc is a recordable disc or a re-writeable disc, identifying formats of the last two blocks of a track in a closed session of the disc when the lead-in area of the disc comprises the program memory area, and determining the write type of the disc according to the formats of the last two blocks.

### BACKGROUND OF THE INVENTION

1. Field of the Invention

The present invention provides a method for determining a write type of a disc, and more particularly, a method for determining the write type of the disc according to formats of the last two blocks of a track in a closed session of the disc.

2. Description of the Prior Art

In modern information society, small, light, high-density, and low-cost optical discs have become one of the most popular non-volatile storage media. When burning data into discs, formats of the discs include a music CD, data or software discs for PCs, a VCD, a CD-interactive, a photo CD defined by Kodak®, console game CDs such as Sony® Play Station and Sega® Saturn CDs. Therefore, according to different formats, users can backup or make a copy of specific data. In a burning procedure of a recordable disc, before writing data, a burning drive determines an optimal laser power in a power calibration area, or PCA, writes start and end positions of a current track in a program memory area, or PMA, and writes tables of a last session and current sessions in a table of contents, or TOC, in a lead-in area. After writing data, the drive writes a lead-out area, so as to discriminate from the next session if the disc is not yet closed.

In general, a write type of a disc can be categorized into the following types:

1. Session at once (SAO): SAO is most probably used for burning a CD-Extra. With SAO, a laser head of the drive is switched off after a session including a plurality of tracks is burned, and switched on when burning the next session.

2. Track at once (TAO): TAO means that data is written into a disc track by track. In a TAO disc, each session is allowed to include a plurality of tracks with non-consecutive data. When burning the TAO disc, a data area is burned first, and then a lead-in area and a lead-out area are burned, so TAO can be applied for multi-time writing, but there are “gaps” between tracks in the TAO disc.

3. Disc at once (DAO): DAO means that all data are written into a disc at one time. A DAO disc is closed after being written, so DAO type cannot be applied for multi-time writing.

4. Packet writing: Packet writing means that data are divided into small packets, and the packets are written into a disc. Lengths of the packets can be unchangeable or changeable.

A user can select a write type according to different requirements. For example, if the user wants to store data having just a few megabytes, the user can choose a write type of non-DAO (such as TAO), so as to use the remaining space of the disc afterwards. Therefore, disc drives or burning drives (generally, only burning drives can read discs not yet closed) must determine the write types of discs first, and then perform reading or writing operations. Especially for SAO and TAO, a lead-in area of a SAO disc does not necessarily include the PMA, so it is easy to wrongly determine that a SAO disc is a TAO disc. Since different write types correspond to different operations of reading and writing in a disc drive, the prior art may damage user's data when burning a disc if a write type of the disc is not determined accurately.

### SUMMARY OF THE INVENTION

It is therefore a primary objective of the claimed invention to provide a method for determining a write type of a disc.

According to the claimed invention, a method for determining a write type of a disc includes: determining whether the disc is a recordable disc or a re-writeable disc; determining whether a lead-in area of the disc comprises a program memory area or not when the disc is a recordable disc or a re-writeable disc; identifying formats of the last two blocks of a track in a closed session of the disc when the lead-in area of the disc comprises the program memory area; and determining the write type of the disc according to the formats of the last two blocks.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a process for determining a write type of a disc in accordance with the present invention.

FIG. 2 illustrates a flowchart of a preferred embodiment process for determining a write type of a disc in accordance with the present invention.

### DETAILED DESCRIPTION

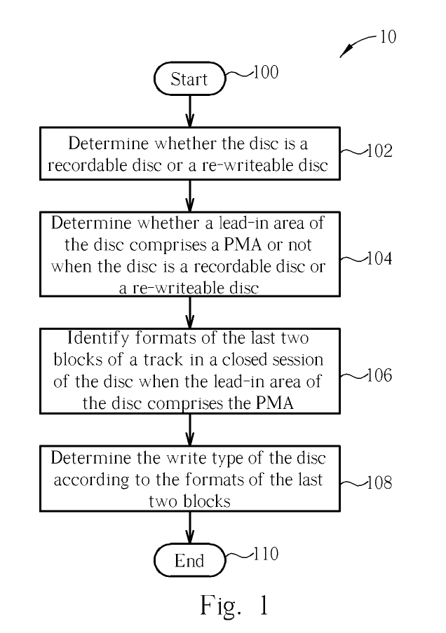

Please refer to FIG. 1, which illustrates a flowchart of a process 10 in accordance with the present invention. The process 10 is used to determine a write type of a disc. The disc is not limited to any one kind of optical storing media, and can be a digital versatile disc or other optical discs. The process 10 includes the following steps:

Step 100: start.

Step 102: determine whether the disc is a writeable disc.

Step 104: determine whether a lead-in area of the disc comprises a PMA or not when the disc is a recordable disc or a re-writeable disc.

Step 106: identify formats of the last two blocks of a track in a closed session of the disc when the lead-in area of the disc comprises the PMA.

Step 108: determine the write type of the disc according to the formats of the last two blocks.

Step 110: finish.

The writeable disc mentioned in step 102 includes a recordable disc and a re-writeable disc.

In short, when the lead-in area of the disc includes the PMA, the present invention process 10 determines the write type of the disc according to the formats of the last two blocks of the track in the closed session. Regarding to TAO, a laser head of a burning drive is switched off and on when burning each track, so between tracks, there are gaps including a run-out area and a run-in area. Therefore, in a TAO disc, the last two blocks of a track are run-out blocks. Based on the last two blocks, the present invention can determine the write type. For example, the present invention determines that the write type of the disc is SAO if the last two blocks are data blocks, the write type of the disc is TAO if the last two blocks are run-out blocks, and the write type of the disc is DAO or SAO if the last two blocks cannot be identified. As a result, according to the present invention, a disc drive or a burning drive can determine a write type of a disc accurately, so as to perform reading or writing operations. In addition, since a lead-in area of a TAO disc must include a PMA but a lead-in area of a SAO disc does not necessarily include a PMA, the present invention can determine that a write type of a disc is DAO or SAO if a lead-in area of the disc does not include any PMA. Moreover, if formats of the last two blocks of a track in a closed session of a disc cannot be identified, the present invention can identify the last two blocks of another track. If the present invention cannot identify the last two blocks for a plurality of tracks in a disc, or if there are no other tracks in the session, then the present invention determines that a write type of the disc is DAO or SAO. What should be noted is that the present invention process 10 is used to determine a write type of a disc, and the disc is not limited to any one kind of optical media.

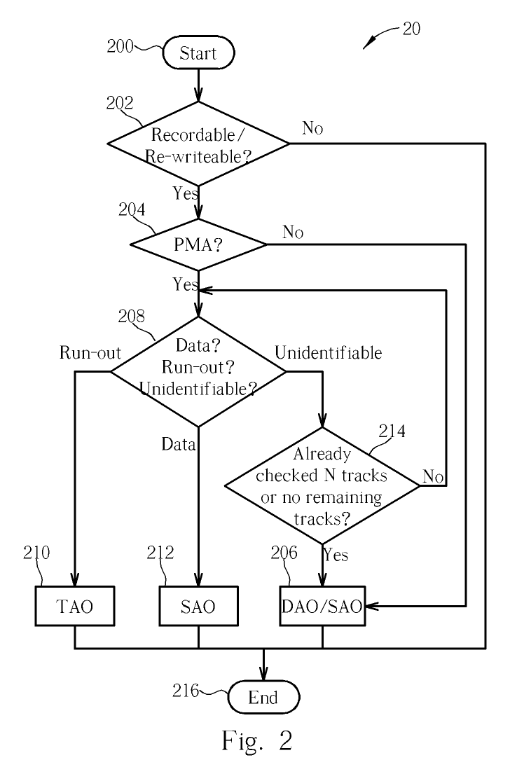

Continuing with the process 10, please refer to FIG. 2, which illustrates a flowchart of a preferred embodiment process 20 in accordance with the present invention. The process 20 is used to determine a write type of a disc. The disc is not limited to any one kind of optical storing media, and can be a digital versatile disc or other optical discs. The process 20 includes the following steps:

Step 200: start.

Step 202: determine whether the disc is writeable disc. If yes, go to step 204, otherwise, go to step 216.

Step 204: determine whether a lead-in area of the disc comprises a PMA or not. If yes, go to step 208, otherwise, go to step 206.

Step 206: determine that the write type of the disc is DAO or SAO, and go to step 216.

Step 208: identify whether last two blocks of a track in a closed session of the disc are data blocks, run-out blocks, or unidentifiable blocks. If the blocks are data blocks, go to step 212, if the blocks are run-out blocks, go to step 210, and if the blocks cannot be identified, go to step 214.

Step 210: determine that the write type of the disc is TAO, and go to step 216.

Step 212: determine that the write type of the disc is SAO, and go to step 216.

Step 214: identify the last two blocks of another track in the closed session. If N tracks have already been checked or if there no remaining tracks to identify, go to 206.

Step 216: finish.

Therefore, according to the process 20, after confirming that a disc is a recordable disc or a re-writeable disc, the present invention determines whether a lead-in area of the disc comprises the PMA or not. If the lead-in area does not comprise the PMA, then the present invention determines that a write type of the disc is DAO or SAO. Oppositely, if the lead-in area comprises the PMA, the present invention identifies whether last two blocks of a track in a closed session of the disc are data blocks, run-out blocks, or unidentifiable blocks. If the blocks are data blocks, the present invention determines that the write type of the disc is SAO. If the blocks are run-out blocks, the present invention determines that the write type of the disc is TAO. And, if the blocks cannot be identified, the present invention identifies other last two blocks. If the present invention checks N tracks but still cannot identify the last two blocks, or there are no other tracks, then the present invention determines that the write type of the disc is DAO or SAO. The “N” can be set according to the required efficiency, such as N=1 for high efficiency. Therefore, by the process 20, the present invention can determine the write type of the disc with high accuracy and high speed.

In summary, if the lead-in area of the disc includes the PMA, the present invention determines the write type of the disc according to the last two blocks of the track in the closed session, where the disc is not limited to any one kind of optical storing media. Since different write types of discs correspond to different operations of reading and writing in a disc drive, the write types must be identified accurately. The present invention is based on the last two blocks of the track in the closed session, so as to increase efficiency and accuracy, and improve the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for determining a write type of a disc comprising following steps:
(a) determining whether the disc is a writeable disc;
(b) determining whether a lead-in area of the disc comprises a program memory area when the disc is a writeable disc;
(c) identifying formats of the last two blocks of a track in a closed session of the disc when the lead-in area of the disc comprises the program memory area; and
(d) determining the write type of the disc according to the formats of the last two blocks.

2. The method of claim 1, wherein in step (d), the write type of the disc is determined to be session at once when the last two blocks are data blocks.

3. The method of claim 1, wherein in step (d), the write type of the disc is determined to be track at once when the last two blocks are run-out blocks.

4. The method of claim 1, wherein step (c) further comprises when the lead-in area comprises the program memory area, identifying formats of the last two blocks of another track in the closed session, and when the formats of the last two blocks of the another track are incapable of being identified, identifying the formats of the last two blocks of the track in the closed session.

5. The method of claim 1, wherein step (d) further comprises when formats of the last two blocks of at least one track are incapable of being identified, determining that the write type of the disc is disc at once or session at once.

6. The method of claim 1, wherein step (c) further comprises when the lead-in area of the disc does not comprise the program memory area, determining that the write type of the disc is disc at once or session at once.

7. The method of claim 1, wherein the disc is a digital versatile disc.
